(19) United States
(12) Patent Application Publication
(10) Pub. No.: US 2026/0099763 A1
(43) Pub. Date: Apr. 9, 2026

(54) ARTIFICIAL INTELLIGENCE MODEL EXPLAINER FOR NON-NUMERICAL DATA TYPES

(71) Applicant: International Business Machines Corporation, Armonk, NY (US)

(72) Inventors: Meng Wan, BEIJING (CN); Xiang Yu Xue, Rizhao City (CN); Sheng Yan Sun, Beijing (CN); Mai Zeng, Shi Jing Shan (CN)

(21) Appl. No.: 18/909,233

(22) Filed: Oct. 8, 2024

(51) Int. Cl. G06N 20/00

(52) U.S. Cl. CPC G06N 20/00

(57) ABSTRACT

Mechanisms are provided for performing an artificial intelligence (AI) model explainer for an AI computer model. The mechanisms receive input data comprising non-numeric feature data, which may be results generated by the AI computer model. The mechanisms process the non-numeric feature data via a first computer model trained to convert non-numeric feature data into a numeric representation of the non-numeric feature data. The mechanisms input the numeric representation of the non-numeric feature data into the AI model explainer to generate an AI model explanation output having a portion corresponding to the numeric representation of the non-numeric feature data. The mechanisms process the AI model explanation output via a second computer model that is trained to convert the portion from the numeric representation to an output non-numeric representation consistent with the non-numeric feature data and the converted output may then be output.

### BACKGROUND

The present application relates generally to an improved data processing apparatus and method and more specifically to an improved computing tool and improved computing tool operations/functionality for providing an artificial intelligence model explainer that efficiently handles non-numerical data types.

Artificial Intelligence (AI) computer models are becoming a key technology in modern industries. While AI computer models provide a significant improvement to such industries, as the AI computer models become increasingly large and complex, and the number of features upon which they operate increases, their operation, and the reasoning as to why the AI computer model generates the results that they generate, is difficult to determine. That is, a user of an AI computer model may know the inputs provided to the AI computer model, and may receive the output of the AI computer model, but is not aware of how the AI computer model generated that output or what influenced the AI computer model in generating that output.

To address such issues, AI explainer algorithms have been developed, examples of which include Local Interpretable Model-agnostic Explanations (LIME) authored by Hvitfeldt et al., and the open source Shapley Additive exPlanations (SHAP). These algorithms operate to determine the set of features in the original data that drives the output or results generated by the AI computer model. This problem is complex in that the influence cannot be determined simply on magnitude, but various other factors, such as scale (e.g., a feature of minutes will have values much larger than a feature of days) of the features and the like, as well as AI model operational parameters themselves, all of which influence the output or results in a complex manner. Thus, an AI model explainer may identify the relatively small set of features, from the input, that influenced more significantly the particular output or result one wants to investigate.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method, in a data processing system, is provided for performing an artificial intelligence (AI) model explainer for an AI computer model. The method comprises receiving input data comprising non-numeric feature data. The input data comprises results generated by the AI computer model. The method further comprises processing the non-numeric feature data via a first computer model that is trained, through machine learning training operations, to convert non-numeric feature data into a numeric representation of the non-numeric feature data. In addition, the method comprises inputting the numeric representation of the non-numeric feature data into the AI model explainer to generate an AI model explanation output for the results of the AI computer model. The AI model explanation output comprises a portion corresponding to the numeric representation of the non-numeric feature data. Moreover, the method comprises processing the AI model explanation output via a second computer model that is trained, through machine learning training operations, to convert the portion of the AI model explanation output from the numeric representation to an output non-numeric representation consistent with the non-numeric feature data, and thereby generate converted AI model explanation output data. The method further comprises outputting the converted AI model explanation output data.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram illustrating numeric and non-numeric input features to an artificial intelligence (AI) computer model which illustrates the issues associated with AI model explainers;

FIG. 2 is an example diagram of a distributed data processing system environment in which aspects of the illustrative embodiments may be implemented and at least some of the computer code involved in performing the inventive methods may be executed;

FIG. 3 is an example block diagram illustrating the primary operational components of a non-numeric data value conversion transformer architecture in accordance with one illustrative embodiment;

FIG. 4 is a flowchart outlining an example operation of a transformer architecture when handling non-numeric data inputs to an AI model explainer in accordance with one illustrative embodiment;

FIG. 5 is a flowchart outlining an example operation of a first transformer, or input transformer, in accordance with one illustrative embodiment; and

FIG. 6 is a flowchart outlining an example operation of a second transformer, or the response transformer, in accordance with one illustrative embodiment.

### DETAILED DESCRIPTION

The illustrative embodiments provide an improved computing tool and improved computing tool operations/functionality for providing an artificial intelligence model explainer that efficiently handles non-numerical data types. As noted above, AI model explainers have been developed to provide greater insights into the reasoning why an AI model generates particular outputs or results by identifying the small set of features that are most influential to the generation of the particular outputs/results. This can be beneficial in answering questions of various types, such as determining the source of bias in the outputs by identifying which features are most influential in generating such biased outputs from the AI computer model. Such AI model explainers are able to operate on numerical values, but cannot operate on data having non-numerical types as they do not know how to interpret non-numerical values.

That is, in many application scenarios, input and output data are not always of a numerical type and the operation of the AI model explainer can only accept numerical values. During the operation of the AI computer model has specific input features and generates particular results, e.g., predictions, classifications, or the like, based on these input features. Thus, specific code is needed to process each non-numeric feature separately and, if the generated result is of a non-numeric type, a secondary conversion of the non-numeric features into numeric values prior to input to the AI computer model explainers is also required in order for AI computer model explainers to operate properly. However, the input data and AI computer models are updated and iterated frequently, causing a need to frequently modify any such conversion coding each time the data changes due to updates to the input data and/or AI computer models, which is very inefficient as well as resource and time consuming.

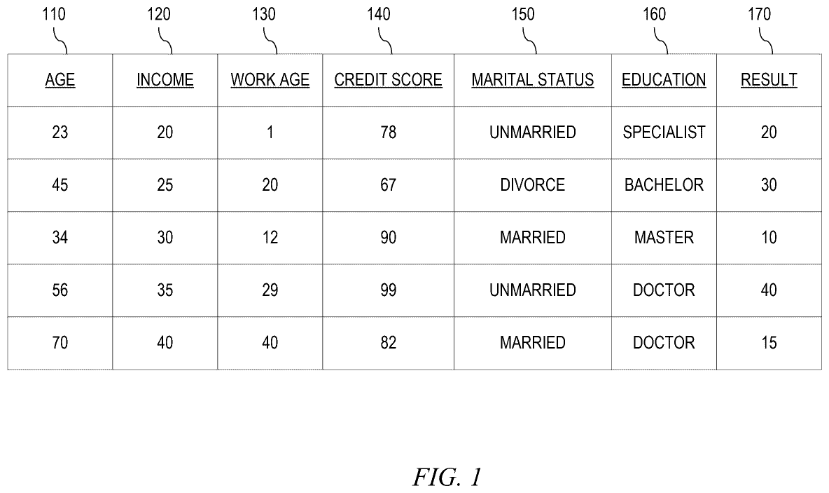

For example, consider an AI computer model that is developed and trained to predict a person's available loan amount. Such an AI computer model may take as inputs, the features 110-160 shown in FIG. 1 and may generate a predicted loan amount result 170. It should be appreciated that this is a simplified example for illustration purposes and actual AI computer models may utilize a much larger set of input features than that shown in FIG. 1. As can be seen from FIG. 1, some of the features 110-140 are numerical input features, whereas other features 150-160 are non-numerical. An AI model explainer attempting to identify the influential features and reasoning for the result 170 will not know how to interpret the non-numerical feature values shown for features 150-160 as it does not know how to quantify “unmarried” or “specialist” or “divorced”, etc., let alone determine how such non-numerical features influence the output result 170. Thus, code must be developed for converting these non-numerical values to quantified values and this code will be specific to the particular input features and the AI computer model.

However, if the input data and/or AI computer model are updated or modified to add additional possible non-numerical values for the input features, or new non-numerical input features are added to those shown in FIG. 1, then it becomes necessary to write new conversion code in order to enable the AI model explainer to interpret and utilize this new non-numerical feature or non-numerical value. For example, if a new input feature of “real estate” is to be added having non-numerical values, e.g., “single family home”, “apartment dweller”, “landlord”, etc., a new conversion code will need to be developed in order to be able to handle this new non-numeric input feature. Similarly, if a new non-numeric data value of “High School” is added to the “Education” input feature 160, then a new conversion code will need to be developed for understanding what the value “High School” means with regard to an AI model explainer.

In order to solve the computational difficulties and problems caused by non-numerical coding in AI model explainers, the illustrative embodiments provide an improved computing tool and improved computing tool operations/process to handle non-numeric data types. The illustrative embodiments provide an optimization tool and process for AI model interpretation that comprises an input data transformer model that takes non-numerical data types, that are the subject of an AI model explainer, as input and converts these non-numerical data types into a numerical representation. A first caching mechanism is utilized to collect data and assist in the training of the input data transformer model (IDT) model. The converted numerical representation is used for AI model explanation generation by the AI model explainer. The explanation results are then restored to the original non-numerical types through a response transformer model. A second caching mechanism is provided for data collection for the explanation responses to assist in training the response transformer (RT) model. The illustrative embodiments eliminate the need to provide and maintain code for conversion of non-numeric values to numeric values prior to building and executing an AI model explainer, and instead provide a machine learning computer model solution that is automatically and incrementally retrained based on cached data in the first and second cache mechanisms to adjust the conversion of non-numeric data types to numeric representations both in the input features and the results of an AI model.

The following description provides examples of embodiments of the present disclosure, and variations and substitutions may be made in other embodiments. Several examples will now be provided to further clarify various aspects of the present disclosure.

Example 1: A method, in a data processing system, for improving the operation of an artificial intelligence (AI) model explainer for an AI computer model. The method comprises receiving input data comprising non-numeric feature data, wherein the input data comprises results generated by the AI computer model. The method also comprises processing the non-numeric feature data via a first computer model that is trained, through machine learning training operations, to convert non-numeric feature data into a numeric representation of the non-numeric feature data.

Moreover, the method comprises inputting the numeric representation of the non-numeric feature data into the AI model explainer to generate an AI model explanation output for the results of the AI computer model, where the AI model explanation output comprises a portion corresponding to the numeric representation of the non-numeric feature data. The method further comprises processing the AI model explanation output via a second computer model that is trained, through machine learning training operations, to convert the portion of the AI model explanation output from the numeric representation to an output non-numeric representation consistent with the non-numeric feature data, and thereby generate converted AI model explanation output data. The method also comprises outputting the converted AI model explanation output data.

The above limitations advantageously enable AI model explainers to be able to operate on non-numeric data inputs and evaluate these non-numeric data inputs with regard to generating explanations of AI model behavior. The above limitations allow AI model explainers to be able to quantify the effects of non-numeric data on AI models so that a more accurate and comprehensive explanation of AI model behavior may be provided as output to an authorized user so that the authorized user can verify proper operation of the AI model or identify where modifications to the AI model need to be made to ensure proper operation of the AI model.

Example 2: The limitations of any of Examples 1 or 3-10, where the first computer model and second computer model are transformer computer models. The above limitation advantageously enables the implementation of AI computer models with multi-head attention mechanisms to learn over time the way in which to convert non-numeric data into numeric representations and numeric representations back into non-numeric data that is consistent with the original non-numeric data inputs.

Example 3: The limitations of any of Examples 1-2 and 4-10, where the first computer model is incrementally retrained with a cached plurality of non-numeric feature data input to the AI computer model, and the second computer model is incrementally retrained with a cached plurality of the numeric representations of non-numeric feature data associated with the second computer model. The above limitations advantageously enable the computer models to improve their machine learning training over time as new non-numeric feature data is encountered and thereby expands the capabilities of the computer models to process increasingly different types of non-numeric feature data. Moreover, these limitations permit the computer models to be adapted to changes in both the non-numeric features being utilized as well as the non-numeric values associated with these non-numeric features.

Example 4: The limitations of any of Examples 1-3 and 5-10, where the first computer model has an associated first cache that collects non-numeric feature data not able to be converted by the first computer model into a numerical representation, and wherein the incremental retraining of the first computer model is initiated on a periodic basis using the collected non-numeric feature data stored in the first cache, wherein the periodic basis is when either a predetermined amount of time has expired since a previous retraining of the first computer model or a predetermined amount of non-numeric data is stored in the first cache. The above limitations advantageously enable the caching of data not able to be properly processed by the first computer model so that the cached data can then later be used for incremental training of the first computer model and thereby expand its capabilities in processing non-numeric feature data to convert to numeric representations usable by the AI model explainer.

Example 5: The limitations of any of Examples 1-4 and 6-10, where the second computer model has an associated second cache that collects numeric representations of non-numeric feature data that are not able to be accurately converted by the second computer model to a corresponding non-numeric representation, and wherein the incremental retraining of the second computer model is initiated on a periodic basis using the collected numeric representations, wherein the periodic basis is when either a predetermined amount of time has expired since a previous retraining of the second computer model or a predetermined amount of numeric representation data is stored in the second cache. The above limitations advantageously enable the caching of data not able to be properly processed by the second computer model so that the cached data can then later be used for incremental training of the second computer model and thereby expand its capabilities with regard to converting portions of explanations generated by the AI model explainer which contain numeric representations corresponding to non-numeric feature data, such that the number representations are replaced with the appropriate non-numeric feature representations. This will allow for greater readability and understanding by users of the explanations generated by the AI model explainer.

Example 6: The limitations of any of Examples 1-5 and 7-10, where the method further comprises receiving AI computer model data comprising one or more of input feature data that is input to the AI computer model and output results data from an output of the AI computer model, and determines whether the AI computer model data comprises instances of the non-numeric data. The method further comprises directing the instances of the non-numeric data to the first computer model for conversion to numeric representations, and directing instances of numeric data to the AI model explainer. The above limitations advantageously enable the AI model explainer to operate on numeric feature data directly while the non-numeric data is redirected through the first computer model for conversion to numeric representations which the AI model explainer can then process, since the AI model explainer is limited to processing numeric data.

Example 7: The limitations of any of Examples 1-6 and 8-10, where the method further comprises storing a mapping of the non-numeric feature data to the corresponding numeric representation in a catalog, wherein the catalog stores mappings for a plurality of instances of non-numeric feature data to corresponding numeric representations, and wherein the catalog is input to the second computer model and is used by the second computer model to generate the converted AI model explanation output data based on the mappings stored in the catalog. The above limitations advantageously permit the second computer model to make proper conversions of numeric representations, in the AI model explainer generated explanations of AI model behavior, into non-numeric representations which are consistent with the non-numeric feature data that was originally input.

Example 8: The limitations of any of Examples 1-7 and 9-10, where the AI model explanation output data comprises data specifying input features of the AI computer model that are relatively more influential to the results generated by the AI computer model. The above limitations advantageously permit the generation of explanations of AI model behavior that identify which input features are most influential on the operation of the AI model in generating a corresponding output of the AI model. This can inform authorized users of where potential modifications to the AI model may need to be made in order to achieve a desired operation of the AI model. For example, in the case of AI model bias, such explanations can be used to identify potential sources of bias in the AI model and direct authorized user efforts to addressing those sources of bias.

Example 9: The limitations of any of Examples 1-8 and 10, where the numeric representation is a one hot encoding of the non-numeric feature data. The above limitation advantageously provides an encoding that is able to be processed by the AI model explainer yet represents non-numeric feature data in a numeric representation.

Example 10: The limitations of any of Examples 1-9, where the numeric representation is a vector or vector matrix corresponding to the non-numeric feature data. The above limitation advantageously provides an encoding that is able to be processed by the AI model explainer yet represents non-numeric feature data in a numeric vector or matrix data structure understandable to the AI model explainer.

Example 11: A system comprising one or more processors and one or more computer-readable storage media collectively storing program instructions which, when executed by the one or more processors, are configured to cause the one or more processors to perform a method according to any one of Examples 1 - 10. The above limitations advantageously enable a system comprising one or more processors to perform and realize the advantages described with respect to Examples 1 - 10.

Example 12: A computer program product comprising one or more computer readable storage media, and program instructions collectively stored on the one or more computer readable storage media, the program instructions comprising instructions configured to cause one or more processors to perform a method according to any one of Examples 1 - 10. The above limitations advantageously enable a computer program product having program instructions configured to cause one or more processors to perform and realize the advantages described with respect to Examples 1 - 10.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides an AI model explainer non-numeric data value machine learning transformer architecture that automatically learns and executes on non-numeric values to convert non-numeric values to numeric representations and converts numeric results back to non-numeric data after execution of the AI model explainer. The improved computing tool implements mechanism and functionality, such as the AI model explainer transformer architecture, which cannot be practically performed by human beings either outside of, or with the assistance of, a technical environment, such as a mental process or the like. The improved computing tool provides a practical application of the methodology at least in that the improved computing tool is able to automatically learn and apply conversions of non-numeric data values to numeric data values, and vice versa, with regard to the input features and results of AI computer models.

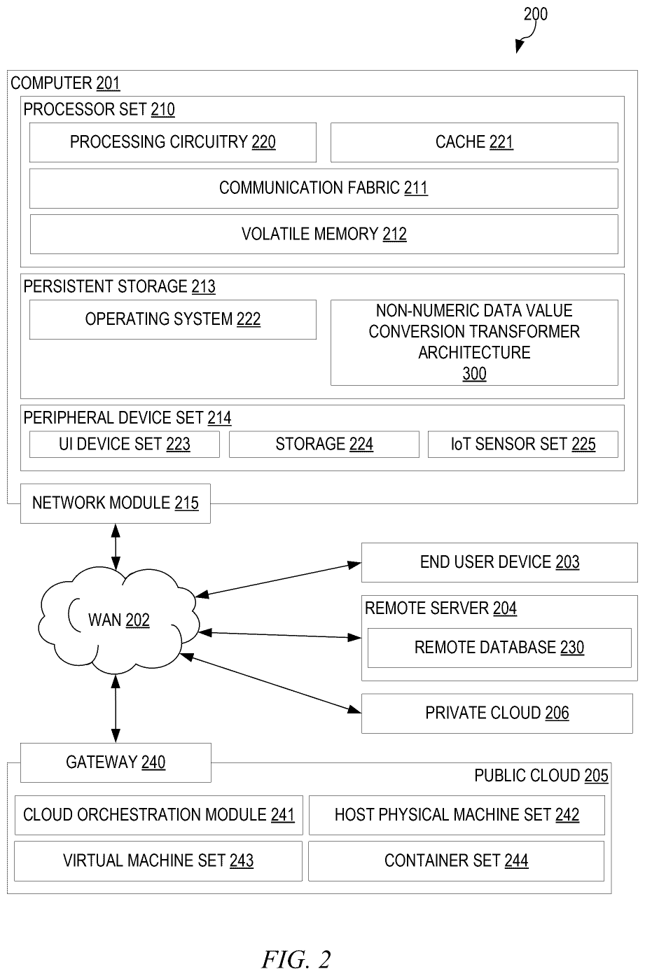

FIG. 2 is an example diagram of a distributed data processing system environment in which aspects of the illustrative embodiments may be implemented and at least some of the computer code involved in performing the inventive methods may be executed. That is, computing environment 200 contains an example of an environment for the execution of at least some of the computer code involved in performing the inventive methods, such as non-numeric data value conversion transformer architecture 300, hereafter referred to simply as the transformer architecture 300. In addition to transformer architecture 300, computing environment 200 includes, for example, computer 201, wide area network (WAN) 202, end user device (EUD) 203, remote server 204, public cloud 205, and private cloud 206. In this embodiment, computer 201 includes processor set 210 (including processing circuitry 220 and cache 221), communication fabric 211, volatile memory 212, persistent storage 213 (including operating system 222 and transformer architecture 300, as identified above), peripheral device set 214 (including user interface (UI), device set 223, storage 224, and Internet of Things (IoT) sensor set 225), and network module 215. Remote server 204 includes remote database 230. Public cloud 205 includes gateway 240, cloud orchestration module 241, host physical machine set 242, virtual machine set 243, and container set 244.

Computer 201 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 230. As is well understood in the art of computer technology, and depending upon the technology, performance of a computer-implemented method may be distributed among multiple computers and/or between multiple locations. On the other hand, in this presentation of computing environment 200, detailed discussion is focused on a single computer, specifically computer 201, to keep the presentation as simple as possible. Computer 201 may be located in a cloud, even though it is not shown in a cloud in FIG. 2. On the other hand, computer 201 is not required to be in a cloud except to any extent as may be affirmatively indicated.

Processor set 210 includes one, or more, computer processors of any type now known or to be developed in the future. Processing circuitry 220 may be distributed over multiple packages, for example, multiple, coordinated integrated circuit chips. Processing circuitry 220 may implement multiple processor threads and/or multiple processor cores. Cache 221 is memory that is located in the processor chip package(s) and is typically used for data or code that should be available for rapid access by the threads or cores running on processor set 210. Cache memories are typically organized into multiple levels depending upon relative proximity to the processing circuitry. Alternatively, some, or all, of the cache for the processor set may be located “off chip.” In some computing environments, processor set 210 may be designed for working with qubits and performing quantum computing.

Computer readable program instructions are typically loaded onto computer 201 to cause a series of operational steps to be performed by processor set 210 of computer 201 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 221 and the other storage media discussed below. The program instructions, and associated data, are accessed by processor set 210 to control and direct performance of the inventive methods. In computing environment 200, at least some of the instructions for performing the inventive methods may be stored in transformer architecture 300 in persistent storage 213.

Communication fabric 211 is the signal conduction paths that allow the various components of computer 201 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 212 is any type of volatile memory now known or to be developed in the future. Examples include dynamic type random access memory (RAM) or static type RAM. Typically, the volatile memory is characterized by random access, but this is not required unless affirmatively indicated. In computer 201, the volatile memory 212 is located in a single package and is internal to computer 201, but, alternatively or additionally, the volatile memory may be distributed over multiple packages and/or located externally with respect to computer 201.

Persistent storage 213 is any form of non-volatile storage for computers that is now known or to be developed in the future. The non-volatility of this storage means that the stored data is maintained regardless of whether power is being supplied to computer 201 and/or directly to persistent storage 213. Persistent storage 213 may be a read only memory (ROM), but typically at least a portion of the persistent storage allows writing of data, deletion of data and re-writing of data. Some familiar forms of persistent storage include magnetic disks and solid state storage devices. Operating system 222 may take several forms, such as various known proprietary operating systems or open source Portable Operating System Interface type operating systems that employ a kernel. The code included in transformer architecture 300 typically includes at least some of the computer code involved in performing the inventive methods.

Peripheral device set 214 includes the set of peripheral devices of computer 201. Data communication connections between the peripheral devices and the other components of computer 201 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 223 may include components such as a display screen, speaker, microphone, wearable devices (such as goggles and smart watches), keyboard, mouse, printer, touchpad, game controllers, and haptic devices. Storage 224 is external storage, such as an external hard drive, or insertable storage, such as an SD card. Storage 224 may be persistent and/or volatile. In some embodiments, storage 224 may take the form of a quantum computing storage device for storing data in the form of qubits. In embodiments where computer 201 is required to have a large amount of storage (for example, where computer 201 locally stores and manages a large database) then this storage may be provided by peripheral storage devices designed for storing very large amounts of data, such as a storage area network (SAN) that is shared by multiple, geographically distributed computers. IoT sensor set 225 is made up of sensors that can be used in Internet of Things applications. For example, one sensor may be a thermometer and another sensor may be a motion detector.

Network module 215 is the collection of computer software, hardware, and firmware that allows computer 201 to communicate with other computers through WAN 202. Network module 215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 215 are performed on the same physical hardware device. In other embodiments (for example, embodiments that utilize software-defined networking (SDN)), the control functions and the forwarding functions of network module 215 are performed on physically separate devices, such that the control functions manage several different network hardware devices. Computer readable program instructions for performing the inventive methods can typically be downloaded to computer 201 from an external computer or external storage device through a network adapter card or network interface included in network module 215.

WAN 202 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 203 is any computer system that is used and controlled by an end user (for example, a customer of an enterprise that operates computer 201), and may take any of the forms discussed above in connection with computer 201. EUD 203 typically receives helpful and useful data from the operations of computer 201. For example, in a hypothetical case where computer 201 is designed to provide a recommendation to an end user, this recommendation would typically be communicated from network module 215 of computer 201 through WAN 202 to EUD 203. In this way, EUD 203 can display, or otherwise present, the recommendation to an end user. In some embodiments, EUD 203 may be a client device, such as thin client, heavy client, mainframe computer, desktop computer and so on.

Remote server 204 is any computer system that serves at least some data and/or functionality to computer 201. Remote server 204 may be controlled and used by the same entity that operates computer 201. Remote server 204 represents the machine(s) that collect and store helpful and useful data for use by other computers, such as computer 201. For example, in a hypothetical case where computer 201 is designed and programmed to provide a recommendation based on historical data, then this historical data may be provided to computer 201 from remote database 230 of remote server 204.

Public cloud 205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 205 is performed by the computer hardware and/or software of cloud orchestration module 241. The computing resources provided by public cloud 205 are typically implemented by virtual computing environments that run on various computers making up the computers of host physical machine set 242, which is the universe of physical computers in and/or available to public cloud 205. The virtual computing environments (VCEs) typically take the form of virtual machines from virtual machine set 243 and/or containers from container set 244. It is understood that these VCEs may be stored as images and may be transferred among and between the various physical machine hosts, either as images or after instantiation of the VCE. Cloud orchestration module 241 manages the transfer and storage of images, deploys new instantiations of VCEs and manages active instantiations of VCE deployments. Gateway 240 is the collection of computer software, hardware, and firmware that allows public cloud 205 to communicate through WAN 202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 206 is similar to public cloud 205, except that the computing resources are only available for use by a single enterprise. While private cloud 206 is depicted as being in communication with WAN 202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 205 and private cloud 206 are both part of a larger hybrid cloud.

As shown in FIG. 2, one or more of the computing devices, e.g., computer 201 or remote server 204, may be specifically configured to implement a non-numeric data value conversion transformer architecture 300. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computer 201 or remote server 204, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates conversion of non-numeric data types to numeric representations for use with AI model explainers and then converting the numeric representations output by the AI model explainers back into the original non-numeric data types.

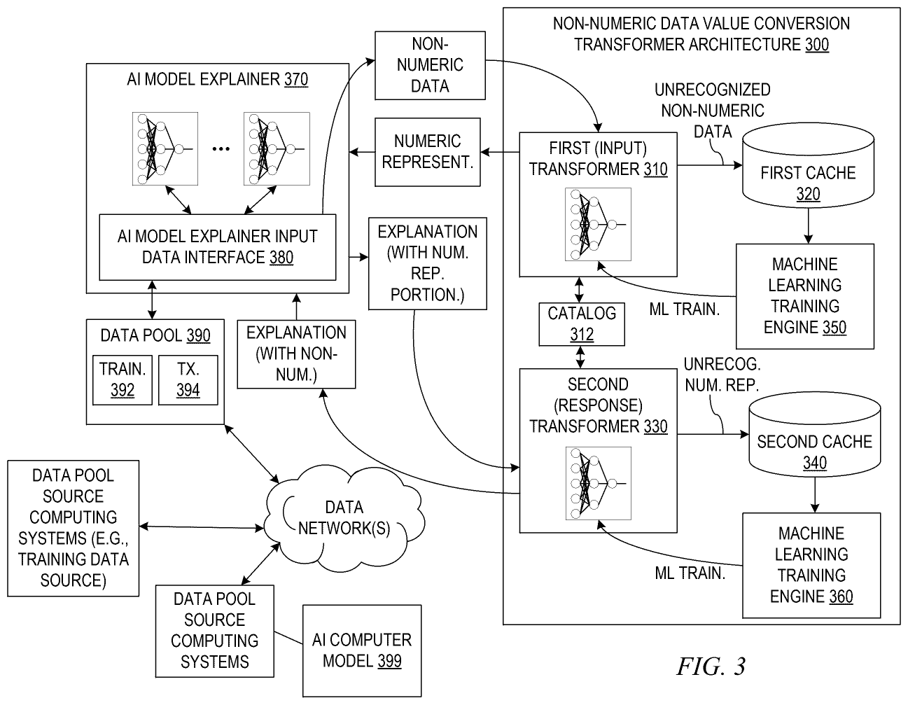

FIG. 3 is an example block diagram illustrating the primary operational components of a non-numeric data value conversion transformer architecture in accordance with one illustrative embodiment. The operational components shown in FIG. 3 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though inputs may be provided by human beings in some cases and the resulting output may aid human beings. The invention is specifically directed to the automatically operating computer components directed to improving the way that AI model explainers operate, and providing a specific solution that is specifically directed to solving the problems associated with non-numeric data types and AI model explainers. The illustrative embodiments implement a specific non-numeric data value conversion transformer architecture that cannot be practically performed by human beings as a mental process and is not directed to organizing any human activity.

As shown in FIG. 3, the transformer architecture 300 comprises a first transformer 310 that transforms non-numeric data types into numeric representations, and a second transformer 330 that transforms numeric representations of AI model explainer results into non-numeric representations corresponding to the original non-numeric representations in an original data catalog. The transformer is a specific type of deep learning AI computer model that utilizes an attention mechanism. With a transformer type AI computer model, text is converted to tokens and each token is converted into a vector via lookup up from a word embedding table. Each token is then contextualized within the scope of a context window with other tokens via a parallel multi-head attention mechanism allowing the signal for key tokens to be amplified and less important tokens to be diminished. It should be appreciated that while a transformer type AI computer model is used in the example embodiments described herein, other illustrative embodiments may be implemented using other types of AI or machine learning computer models which may be trained through machine learning training operations to convert non-numeric features into numeric representations and to convert numeric portions of an AI model explainer output back into a corresponding non-numeric representation.

In addition to the first and second transformers 310, 330, the transformer architecture 300 further comprises a first cache 320 corresponding to the first transformer 310 and a second cache 340 corresponding to the second transformer 330. The first cache 320 and second cache 340 are used to collect data from the corresponding transformers 310, 330 that can be used for further incremental training of the first transformers 310 and 330. That is, the machine learning training engines 350, 360 are provided for training the first transformer 310 and second transformer 330, respectively, based on cached data in the first cache 320 and second cache 340. The two machine learning training engines 350, 360 may operate to perform an initial training of the first transformer 310 and second transformer 330, respectively, as well as perform incremental machine learning training after deployment of the first transformer 310 and second transformer 330 for runtime operation so as to adapt these transformers 310, 330 to new data types and new input features as they are encountered.

The transformer architecture 300 may operate in conjunction with an AI model explainer 370, which may take the form of any known or later developed AI model explainer, such as LIME or SHAP explainers, or the like. The illustrative embodiments may include an AI model explainer input data interface 380 that evaluates input data 392, 394, such as from an input data pool 390, to determine if the input data 390 comprises non-numeric data. The AI model explainer input data interface 380 directs non-numeric data to the first transformer 310, also referred to as an input transformer, for conversion to a numeric representation and directs numeric data to the AI model explainer 370. The input data pool 390 may comprise one or more sets of input data 392, 394. For example, the input data 392 may comprise training data used to train the transformers 310, 330 during a training phase of operation, and may comprise runtime transaction data 394 when operating after deployment of the AI model explainer 370 for runtime use. The data in the input data pool 390 represents the results generated by the AI model 399 that is the subject of the AI model explainer 370 and thus, the AI model explainer 370 is trained to provide explanations for the operation of the AI model 399. For example, if the AI model 399 is configured to determine the loan amount for a user, then the input data pool 390 may comprise data representing all the data involved in determining the loan amount for the user, including the input features to the AI model, the corresponding output generated by the AI model, and the like. As discussed hereafter, the data in the data pool 390 may also include the data that was not able to be processed by the AI model explainer 370, e.g., non-numeric data or the like, and thus, will be processed by the mechanisms of the illustrative embodiments and added to the data pool 390 for incremental re-training of the transformers 310 and 330.

The non-numeric data in the input data 392, 394 from the data pool 390, as identified by the interface 380, is input to the first transformer 310. The non-numeric data is identified by the interface 380 based on the encoding of the data which can be recognized as a non-numeric encoding. If the first transformer 310 has already learned how to convert the non-numeric data into a numeric format, then it is recognized by the first transformer 310 and converted. The first transformer 310 converts the non-numeric data into a numeric representation based on a training of the first transformer 310. If the first transformer 310 does not recognize the non-numeric data, i.e., the conversion has not yet been learned by the first transformer 310, that non-numeric data is cached in the first cache 320 for later incremental training of the first transformer 310 and the AI model explainer 370 operates without the assistance of the unrecognized non-numeric data for explainability. Eventually, once sufficient data is present in the cache 320 and/or after a predetermined period of time of operation, incremental machine learning training is performed by the machine learning training engine 350 on the first transformer 310 to update the training of the first transformer 310 to recognize the data types and/or new input features represented by the data cached in the cache 320.

The first transformer 310 may keep a catalog 312 of the non-numeric data that is converted to a numerical representation. The catalog 312 is used to map the resulting data back to the non-numerical data for presentation of the explanation results so that they are in terms of the original input data. For example, if the first transformer 310 transforms the value of a marital status of “Divorced” to a numerical representation, this information is stored in the catalog 312, such that when that numerical representation is included in the AI model explainer 370 output or results, it can then be converted back to the non-numerical data so that the results of the AI model explainer 370 are presented in terms of the input data 392, 394 from the data pool 390.

The numeric data and the converted non-numeric data, which is in a numeric representation, may be input to the AI model explainer 370 for use in generating explanations for the results or output of the AI model 399. The output of the AI model explainer 370 may then be input to the second transformer 330, also referred to as the response transformer, which operates to convert the numeric representations of the converted non-numeric data back into the non-numeric data. The second transformer 330 is trained through machine learning training to convert the numeric representations of non-numeric data back into non-numeric values. Similar to the cache 320, the cache 340 stores the data for newly added non-numerical features and non-numerical data values that are not able to be accurately converted by the second transformer 330. The cached data in cache 340 may be used to adaptively and incrementally train the second transformer 330 to perform the conversion from numeric representations to non-numeric data values corresponding to the original input data 392, 394 from the data pool 390.

Thus, with the mechanisms of the illustrative embodiments, the first transformer 310 is trained through machine learning training to convert non-numeric input data to a numeric representation for processing by the AI model explainer 370. The AI model explainer 370 operates on the numeric representation to generate one or more explanation outputs which are input to the second transformer 330. The second transform is trained through machine learning training to convert the numeric representations in the AI model explainer 370 output back into non-numeric values corresponding to the non-numeric inputs that were converted. Thus, the transformer architecture 300 provides an improved computing tool and improved computing tool operations/functionality that permits AI model explainers 370 to operate on non-numeric input data and yet generate explanations that can be correlated with this non-numeric input data, which otherwise is not possible with existing AI model explainers which only operate on numeric inputs.

As noted above, the first and second transformers 310 and 320 are trained through machine learning processes both during an initial training using training data 392 and also incrementally based on data collected in the caches 320 and 340. Machine learning may be performed in different forms including supervised, unsupervised, and semi-supervised techniques. Machine learning involves the input of training data, representing the input features that the AI computer model is expected to process to generate output results, e.g., predictions, classifications, or the like. The training data further includes the ground truth data representing the correct results that the AI computer model should generate given the inputs specified in the training data. The training data inputs are input to the AI computer model which then generates an output that is compared to the ground truth to determine an error or loss via a loss function. This error or loss represents how incorrect the AI computer model output is when compared to the ground truth. One or more machine learning algorithms are then executed on this loss to determine modifications to the operational parameters of the AI computer model so as to attempt to minimize the loss or error. This process is repeated through multiple iterations, or epochs, until the model converges, e.g., the error/loss is below a given threshold, the number of iterations has reached a predetermined number of iterations, or the like. Once the AI computer model converges, it is considered trained and ready for testing and deployment for runtime execution. The testing involves a testing data set, similar to the training data set, but which is used to evaluate the performance of the trained AI computer model to ensure that the trained AI computer model is operating with a desired or acceptable performance.

In the case of the first and second transformers 310 and 330, in addition to the original training of these transformers 310 and 330, the illustrative embodiments provide for automated adaptive and incremental training of the transformers 310 and 330 based on the data cached in the respective data caches 320 and 340. Thus, when the transformers 310 and 330 encounter unrecognized data, e.g., non-numeric data in the case of the first transformer 310 and numeric data for which the conversion to non-numeric data is not previously known in the case of the second transformer 330, this unrecognized data is stored in the caches 320 and 340. Once this data reaches a predetermined threshold amount of data, or a predetermined elapsed time is reached since a previous iterative training of the transformers 310 and 330, then the machine learning training engines 350 and 360 may execute incremental fine tuning training of the transformers 310 and 330 based on the cached data in the caches 320 and 340, respectively. It should also be appreciated that this cached data may be sent to the data pool 390 as well to formulate new training data samples in the training data 392 for subsequent retraining of the transformers 310 and 330 or for use in training other instances of the transformers 310 and 330 for other AI model explainers 370.

Thus, the mechanisms of the illustrative embodiments provide an improved computing tool and improved computing tool operations/functionality that includes a transformer architecture that operates to handle non-numeric data types when performing AI model explainer operations. The illustrative embodiments improve AI model training in large-scale cloud environments and comprehensive data types by providing improved AI model explainer capabilities that generate AI model explanations that take into consideration influences of non-numeric features, and these explanations may be used to drive modifications and optimizations of the AI model.

The illustrative embodiments can convert non-numeric data for AI model explainer computations without the need for additional code writing. The illustrative embodiments are able to adapt to changes in the AI model and features operated on by the AI model, as well as adapt to changes in the particular acceptable non-numeric values for particular input features to the AI model. The automatic adaptation of the transformer architecture through incremental machine learning training updates to the transformers of the transformer architecture significantly reduces manual efforts, computing resource consumption, and development time to quickly and frequently adapt the AI model explainer operation to changes in data types and AI models. The resulting improved computing tool and improved computing tool operations/functionality strengthen the explainability and robustness of AI models which improves AI model development.

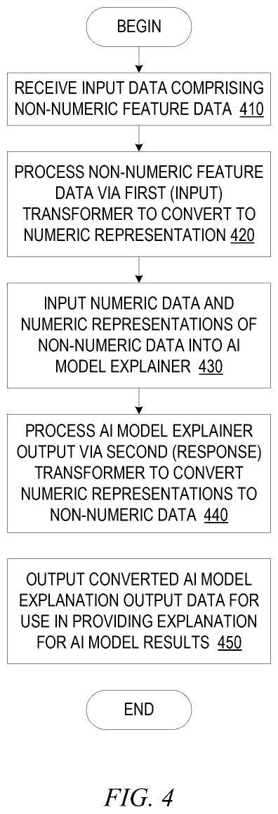

FIGS. 4-6 present flowcharts outlining example operations of elements of the present invention with regard to one or more illustrative embodiments. It should be appreciated that the operations outlined in FIGS. 4-6 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIGS. 4-6, and may, in some cases, make use of the results generated as a consequence of the operations set forth in FIGS. 4-6, the operations in FIGS. 4-6 themselves are specifically performed by the improved computing tool in an automated manner.

FIG. 4 is a flowchart outlining an example operation of a transformer architecture when handling non-numeric data inputs to an AI model explainer in accordance with one illustrative embodiment. As shown in FIG. 4, the operation starts by receiving input data comprising non-numeric feature data, which may be non-numeric feature data in the input features and/or results generated by an AI computer model (step 410). For example, in the case of the loan amount AI computer model discussed previously, the input data may represent the features input to the AI computer model, such as shown in FIG. 1 above, and the resulting outputs generated by the AI computer model, each of which may include non-numeric data values.

The non-numeric feature data is processed via a first transformer computer model that is trained, through machine learning training operations, to convert non-numeric feature data into a numeric representation of the non-numeric feature data (step 420). The numeric representation of the non-numeric feature data is input to the AI model explainer to generate an AI model explanation output for the results of the AI computer model (step 430). The AI model explanation output comprises a portion corresponding to the numeric representation of the non-numeric feature data.

The AI model explanation output is processed via a second transformer computer model that is trained, through machine learning training operations, to convert the portion of the AI model explanation output from the numeric representation to an output non-numeric representation consistent with the non-numeric feature data, and thereby generate converted AI model explanation output data (step 440). The converted AI model explanation output data may then be output for use as an explanation for the AI computer model results that are generated (step 450). The operation then terminates. It should be appreciated that while the flowchart terminates, the explanation generated through the operation of the flowchart may be used to drive outputs of a user interface through which authorized personal may access the explanations to give greater insights into the operation of the AI model which in turn may be used to modify and optimize the AI model for desired operations.

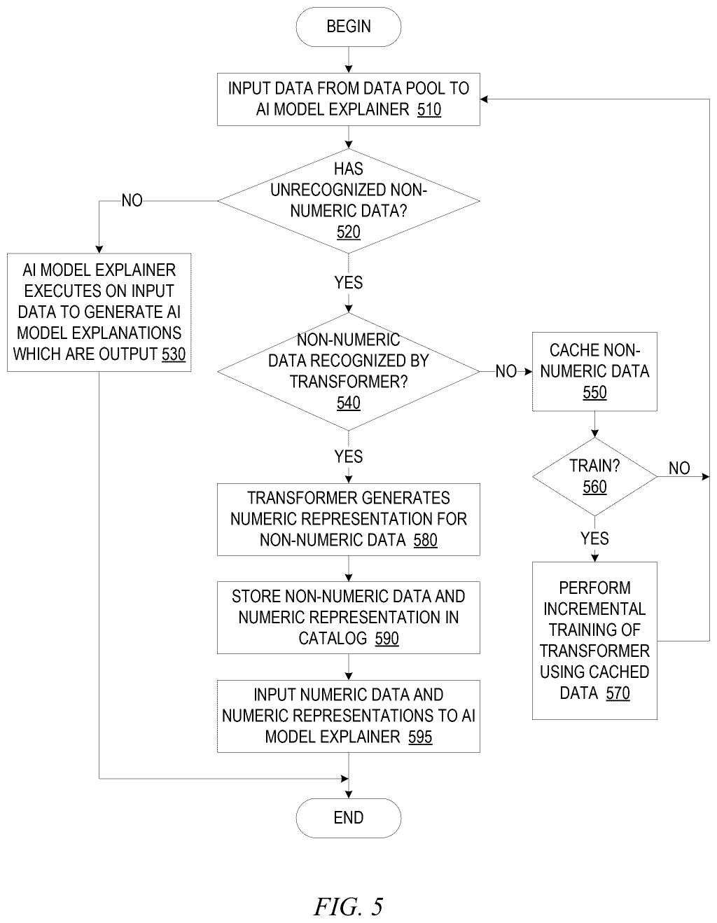

FIG. 5 is a flowchart outlining an example operation of a first transformer, or input transformer, in accordance with one illustrative embodiment. As shown in FIG. 5, the operation starts with data from the data pool being input to the AI model explainer (step 510). A determination is made as to whether the input data from the data pool includes any non-numeric data values that are not recognized by the AI model explainer (step 520). If not, then the AI model explainer executes on the input data in an existing manner to generate AI model explanations which are then output (step 530) and the operation terminates. If the input data comprises non-numeric data values that are not recognized by the AI model explainer, then the operation determines if the first transformer recognizes the non-numeric data (step 540). If not, the non-numeric data is stored in the cache associated with the first transformer (step 550). A determination is made as to whether the conditions of the cache meet an incremental training threshold (step 560) and if so, an incremental retraining of the first transformer is performed using the cached data (step 570) and, whether incremental retraining is performed or not, the operation returns to step 510.

Returning to step 540, if the transformer recognizes the non-numeric data, the first transformer processes the non-numeric data to generate one or more numeric representations for the non-numeric data (step 580). The one or more numeric representations for the non-numeric data may are learned by the transformer and there are many different ways that this numeric representation correlation may be implemented. For example, there may be a direct mapping between non-numeric features and numeric representations, e.g., male=0 and female=1. Moreover, a one hot encoding may be learned, e.g., 1000 for college, 0100 for high school, 0010 for elementary school, or the like. Still further, a vector or matrix vector may be utilized, similar to the one hot encoding. Any suitable correlation of a non-numeric feature to a numeric representation that may be learned by the transformer may be used without departing from the spirit and scope of the present invention.

The converted numeric representations and the original non-numeric data may be stored in a catalog for mapping from one to the other in the second transformer, as described hereafter (step 590). The numeric data in the input data and the converted numeric representations are input to the AI model explainer for processing (step 595). The operation then terminates.

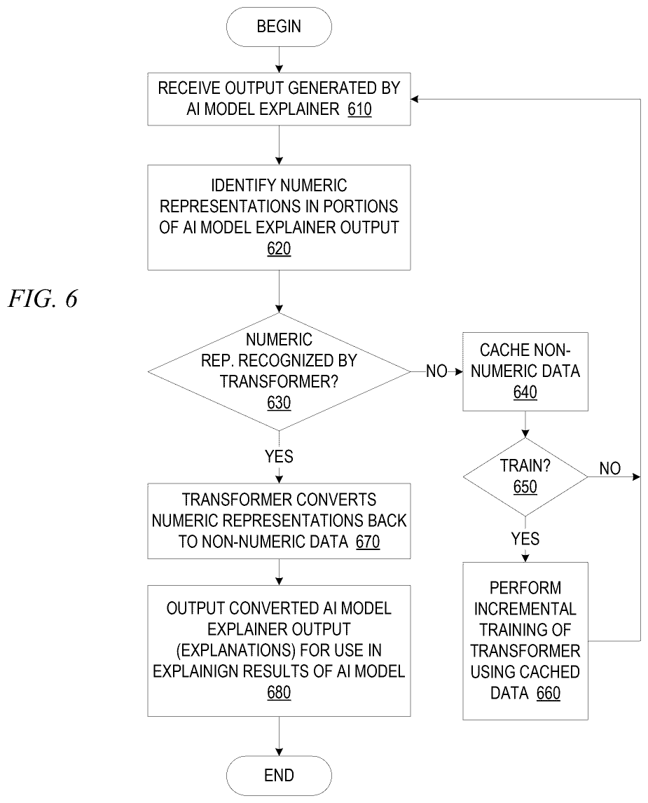

FIG. 6 is a flowchart outlining an example operation of a second transformer, or the response transformer, in accordance with one illustrative embodiment. As shown in FIG. 6, the operation starts with receiving an output generated by the AI model explainer (step 610). This output may comprise one or more portions that reference the numeric representations generated for non-numeric data in the input data to the AI model explainer. These numeric representations may be identified by comparison to a catalog of original non-numeric data mappings to numeric representations generated by the first transformer (step 620). The portions comprising the numeric representations are input to the second transformer to determine whether the numeric representations are not recognized by the second transformer (step 630). If the numeric representations are not recognized, then they are stored in the cache associated with the second transformer (step 640). A determination is made as to whether the conditions of the cache meet an incremental training threshold (step 650) and if so, an incremental retraining of the second transformer is performed using the cached data (step 660) and, whether incremental retraining is performed or not, the operation returns to step 610.

Returning to step 630, if the second transformer recognizes the numeric representations, the second transformer processes the numeric representations to convert them back to the original non-numeric data types (step 670). The resulting converted AI model explainer output may then be generated and output for use in explaining the results generated by the AI model (step 680). The operation then terminates.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, in a data processing system, performing an artificial intelligence (AI) model explainer for an AI computer model, the method comprising:
receiving input data comprising non-numeric feature data, wherein the input data comprises results generated by the AI computer model;
processing the non-numeric feature data via a first computer model that is trained, through machine learning training operations, to convert non-numeric feature data into a numeric representation of the non-numeric feature data;
inputting the numeric representation of the non-numeric feature data into the AI model explainer to generate an AI model explanation output for the results of the AI computer model, wherein the AI model explanation output comprises a portion corresponding to the numeric representation of the non-numeric feature data;
processing the AI model explanation output via a second computer model that is trained, through machine learning training operations, to convert the portion of the AI model explanation output from the numeric representation to an output non-numeric representation consistent with the non-numeric feature data, and thereby generate converted AI model explanation output data; and
outputting the converted AI model explanation output data.

2. The method of claim 1, wherein the first computer model and second computer model are transformer computer models.

3. The method of claim 1, wherein the first computer model is incrementally retrained with a cached plurality of non-numeric feature data input to the AI computer model, and the second computer model is incrementally retrained with a cached plurality of the numeric representations of non-numeric feature data associated with the second computer model.

4. The method of claim 3, wherein the first computer model has an associated first cache that collects non-numeric feature data not able to be converted by the first computer model into a numerical representation, and wherein the incremental retraining of the first computer model is initiated on a periodic basis using the collected non-numeric feature data stored in the first cache, wherein the periodic basis is when either a predetermined amount of time has expired since a previous retraining of the first computer model or a predetermined amount of non-numeric data is stored in the first cache.

5. The method of claim 3, wherein the second computer model has an associated second cache that collects numeric representations of non-numeric feature data that are not able to be accurately converted by the second computer model to a corresponding non-numeric representation, and wherein the incremental retraining of the second computer model is initiated on a periodic basis using the collected numeric representations, wherein the periodic basis is when either a predetermined amount of time has expired since a previous retraining of the second computer model or a predetermined amount of numeric representation data is stored in the second cache.

6. The method of claim 1, further comprising:
receiving AI computer model data comprising one or more of input feature data that is input to the AI computer model and output results data from an output of the AI computer model;
determining whether the AI computer model data comprises instances of the non-numeric data;
directing the instances of the non-numeric data to the first computer model for conversion to numeric representations; and
directing instances of numeric data to the AI model explainer.

7. The method of claim 1, further comprising storing a mapping of the non-numeric feature data to the corresponding numeric representation in a catalog, wherein the catalog stores mappings for a plurality of instances of non-numeric feature data to corresponding numeric representations, and wherein the catalog is input to the second computer model and is used by the second computer model to generate the converted AI model explanation output data based on the mappings stored in the catalog.

8. The method of claim 1, wherein AI model explanation output data comprises data specifying input features of the AI computer model that are relatively more influential to the results generated by the AI computer model.

9. The method of claim 1, wherein the numeric representation is a one hot encoding of the non-numeric feature data.

10. The method of claim 1, wherein the numeric representation is a vector or vector matrix corresponding to the non-numeric feature data.

11. A computer program product comprising a computer readable storage medium having a computer readable program stored therein, wherein the computer readable program, when executed in a data processing system, causes the data processing system to:
receive input data comprising non-numeric feature data, wherein the input data comprises results generated by an artificial intelligence (AI) computer model;
process the non-numeric feature data via a first computer model that is trained, through machine learning training operations, to convert non-numeric feature data into a numeric representation of the non-numeric feature data;
input the numeric representation of the non-numeric feature data into the AI model explainer to generate an AI model explanation output for the results of the AI computer model, wherein the AI model explanation output comprises a portion corresponding to the numeric representation of the non-numeric feature data;
process the AI model explanation output via a second computer model that is trained, through machine learning training operations, to convert the portion of the AI model explanation output from the numeric representation to an output non-numeric representation consistent with the non-numeric feature data, and thereby generate converted AI model explanation output data; and
output the converted AI model explanation output data.

12. The computer program product of claim 11, wherein the first computer model and second computer model are transformer computer models.

13. The computer program product of claim 11, wherein the first computer model is incrementally retrained with a cached plurality of non-numeric feature data input to the AI computer model, and the second computer model is incrementally retrained with a cached plurality of the numeric representations of non-numeric feature data associated with the second computer model.

14. The computer program product of claim 13, wherein the first computer model has an associated first cache that collects non-numeric feature data not able to be converted by the first computer model into a numerical representation, and wherein the incremental retraining of the first computer model is initiated on a periodic basis using the collected non-numeric feature data stored in the first cache, wherein the periodic basis is when either a predetermined amount of time has expired since a previous retraining of the first computer model or a predetermined amount of non-numeric data is stored in the first cache.

15. The computer program product of claim 13, wherein the second computer model has an associated second cache that collects numeric representations of non-numeric feature data that are not able to be accurately converted by the second computer model to a corresponding non-numeric representation, and wherein the incremental retraining of the second computer model is initiated on a periodic basis using the collected numeric representations, wherein the periodic basis is when either a predetermined amount of time has expired since a previous retraining of the second computer model or a predetermined amount of numeric representation data is stored in the second cache.

16. The computer program product of claim 11, wherein the computer readable program further causes the computing device to:
receive AI computer model data comprising one or more of input feature data that is input to the AI computer model and output results data from an output of the AI computer model;
determine whether the AI computer model data comprises instances of the non-numeric data;
direct the instances of the non-numeric data to the first computer model for conversion to numeric representations; and
direct instances of numeric data to the AI model explainer.

17. The computer program product of claim 11, further comprising storing a mapping of the non-numeric feature data to the corresponding numeric representation in a catalog, wherein the catalog stores mappings for a plurality of instances of non-numeric feature data to corresponding numeric representations, and wherein the catalog is input to the second computer model and is used by the second computer model to generate the converted AI model explanation output data based on the mappings stored in the catalog.

18. The computer program product of claim 11, wherein AI model explanation output data comprises data specifying input features of the AI computer model that are relatively more influential to the results generated by the AI computer model.

19. The computer program product of claim 11, wherein the numeric representation is a one hot encoding of the non-numeric feature data.

20. An apparatus comprising:
at least one processor; and
at least one memory coupled to the at least one processor, wherein the at least one memory comprises instructions which, when executed by the at least one processor, cause the at least one processor to:
receive input data comprising non-numeric feature data, wherein the input data comprises results generated by an artificial intelligence (AI) computer model;
process the non-numeric feature data via a first computer model that is trained, through machine learning training operations, to convert non-numeric feature data into a numeric representation of the non-numeric feature data;
input the numeric representation of the non-numeric feature data into the AI model explainer to generate an AI model explanation output for the results of the AI computer model, wherein the AI model explanation output comprises a portion corresponding to the numeric representation of the non-numeric feature data;
process the AI model explanation output via a second computer model that is trained, through machine learning training operations, to convert the portion of the AI model explanation output from the numeric representation to an output non-numeric representation consistent with the non-numeric feature data, and thereby generate converted AI model explanation output data; and
output the converted AI model explanation output data.
